(19) United States
(12) Patent Application Publication
(10) Pub. No.: US 2018/0009167 A1
(43) Pub. Date: Jan. 11, 2018

(54) PRINT HEAD DROP DETECTORS

(71) Applicant: Hewlett-Packard Development Company, L.P., Houston, TX (US)

(72) Inventors: Ignacio Alejandre, Sant Cugat del Valles (ES); Sergi Culubret, Barcelona (ES); Esteve Comas, Sant Quirze del Valles (ES)

(21) Appl. No.: 15/546,595

(22) PCT Filed: Jan. 30, 2015
(86) PCT No.: PCT/EP2015/051959

§ 371 Date: Jul. 26, 2017

(51) Int. Cl. B22F 3/105; G01N 15/06; B29K 105/00

(52) U.S. Cl. CPC B29C 64/371; B22F 3/1055; B33Y 50/02; B29C 64/20; G01N 15/0612; B33Y 30/00; B29C 64/393; B29K 2105/251; B22F 2003/1057; G01N 2015/0693

(57) ABSTRACT

In one example, a print head drop detector (202) is described. The print head drop detector (202) comprises a sampling volume and a fan (208) to cause an airflow though the sampling volume (206). Detection apparatus to detect the presence of non-gaseous material within the sampling volume is also provided.

### BACKGROUND

Three-dimensional object generation apparatus, such additive manufacturing systems that generate objects on a layer-by-layer basis, have been proposed as a potentially convenient way to produce objects. Examples of apparatus for additive manufacturing which utilise ‘inkjet’ techniques to disperse printing agents have been proposed.

### BRIEF DESCRIPTION OF DRAWINGS

Examples will now be described, by way of non-limiting example, with reference to the accompanying drawings, in which:

FIG. 1 is a simplified schematic of an example of three-dimensional object generation apparatus;

FIG. 2 is a simplified schematic of an example of a detector;

FIG. 3 is a graph showing data gathered by a detector in one example;

FIG. 4 is a simplified schematic of another example of three-dimensional object generation apparatus; and

FIGS. 5 and 6 are examples of methods of determining a risk of ignition.

### DETAILED DESCRIPTION

Additive manufacturing techniques may generate a three-dimensional object through solidification of a build material. In some examples, the build material is a powder-like granular material, which may for example be a plastic or metal powder. Build material is deposited and processed layer by layer, usually within a fabrication chamber. A coalescing agent may be selectively distributed onto portions of a layer of build material in a pattern derived from data representing a slice of a three-dimensional object to be generated, so that when energy (for example, heat) is applied to the layer, the build material coalesces and solidifies to form a slice of the three-dimensional object in accordance with the pattern.

In addition to a coalescing agent, in some examples, a coalescence modifier agent, which acts to modify the effects of a coalescing agent, may selectively distributed onto portions of a layer of build material. Such a coalescence modifier agent may act reduce coalescence, for example by producing a mechanical separation between individual particles of a build material, or by preventing the build material from heating sufficiently to cause coalesce when energy is applied. In other examples, it may increase coalescence, for example comprising a plasticiser. A coloring agent, for example comprising a dye or colorant, may in some examples be used as a coalescence agent or a coalescence modifier agent, and/or to provide a particular color for the object. Such agents may be liquid when applied to the build material.

Examples of apparatus for three-dimensional object generation apparatus which utilise ‘inkjet’ techniques to disperse such agents have been proposed. Such apparatus may comprise a print head. An example print head includes a set of nozzles and a mechanism for ejecting a selected agent as a fluid, for example a liquid, through a nozzle. In such examples (and in 2D inkjet printing), a drop detector may be used to detect whether drops are being ejected from individual nozzles of a print head. For example, a drop detector may be used to determine whether any of the nozzles are clogged and would benefit from cleaning or whether individual nozzles have failed permanently.

Where particulate materials are dispersed, for example in the air, there can be a risk that an explosive atmosphere is created. This can be the case even when a material is relatively non-flammable, or inert, when in the form of a packed layer. Other materials (which may include plastics) are flammable even when in a packed layer, but the ignition temperature can be lowered when the material is in the form of a dispersed powder, thus increasing the risk associated with their use.

One of the factors characterising the risk associated with dispersed particles is their concentration in the gaseous environment. For a given material, there may be a threshold concentration above which the risk exceeds reasonable parameters. Another factor is the presence of oxygen (as combustion cannot occur without oxygen). As a result, in some examples of additive manufacturing, the fabrication chamber is flooded with an inert gas. A third factor is an ignition source, such as heat or a electrostatic charge. A degree of heating may be seen in some examples of additive manufacturing processes.

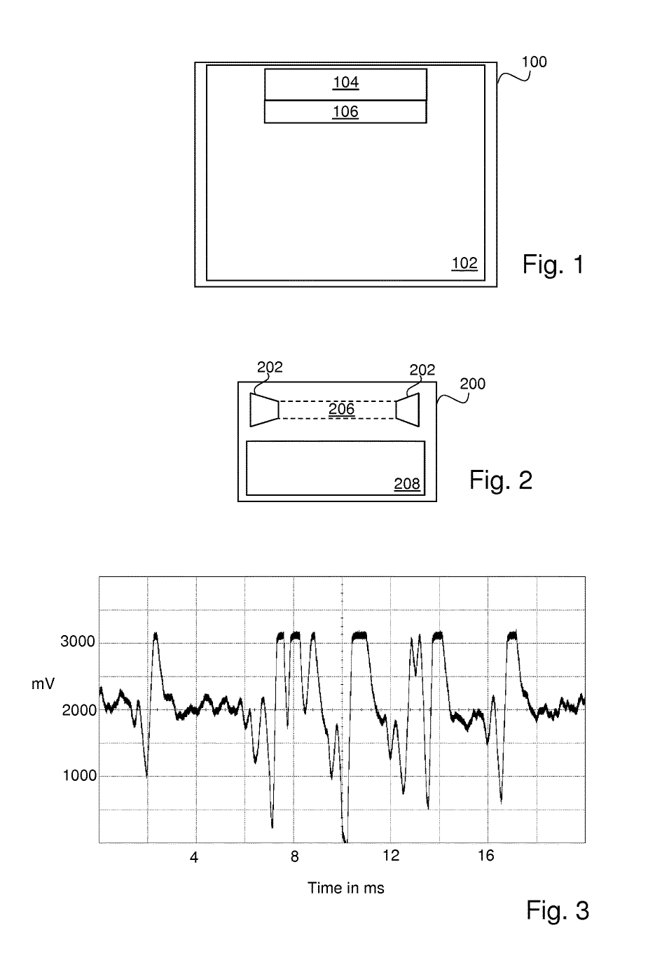

An example of a three-dimensional object generation apparatus is shown in FIG. 1. The apparatus 100 comprises a fabrication chamber 102 in which an object is formed, an agent distributor 104 to selectively deliver an agent onto portions of a layer of a build material within the fabrication chamber 102; and a detector 106 to monitor both the ejection of agent from the agent distributor 104 and the gaseous content of the fabrication chamber 102 for particles which may be dispersed therein. In some examples, the agent distributor 104 is a print head comprising a plurality of nozzles. In some examples, the apparatus is to generate a three-dimensional object from a granular build material. In such examples, the gaseous content of the fabrication chamber 102 may have particles of granular build material suspended therein. In some examples, the fabrication chamber 102 comprises a substantially airtight volume in which a three dimensional object may be fabricated. The apparatus 100 may in some examples be described as an additive manufacturing apparatus.

In some examples, the apparatus 100 may comprise additional components, such as build material distribution apparatus, an energy source, or the like. The fabrication chamber 102 may house a platform on which an object may be formed.

It will be noted that such apparatus 100 uses the same detector 106 to monitor both the ejection of agent from the agent distributor 104 and the concentration of particles, including in some examples granular build material particles. While, in some examples, the majority (even substantially all) of such particles may be build material, other particles may also be dispersed, for example, aerosol of agents (such as ink drops that do not reach the surface of powder and remain suspended in air), and solvents that evaporate from agents and subsequently condense. Therefore, the detector 106 may function as a print head drop detector which functions to monitor the performance of the agent distributor 104, which may in some examples act as a print head. As such a drop detector may be provided in any event, the addition of monitoring apparatus capable of monitoring the presence of potentially dangerous dispersed particles may be made without excessive redesign of existing apparatus.

An example of a print head drop detector 200, which could in some examples function as the detector 106 of FIG. 1, is shown in FIG. 2. The drop detector 200 comprises, in this example, detection apparatus 202. The detection apparatus 202 may have more than one component, for example comprising an emitter and a receiver. The drop detector 200 further comprises a sampling volume 206 and a fan 208 to cause airflow though the sampling volume 206. The fan 208 may comprise any suitable apparatus for causing an airflow. In some examples, a fan of the type used as a cooling fan in a desktop computer may be used.

Where the detection apparatus 202 is an emitter-receiver type (for example a light source and receiver), the sampling volume 206 may be defined by the region between the emitter and the receiver. Other examples may use other technologies such as detecting changes in refractive index, inductive electrification, beta ray monitoring, humidification and the like. In addition, the receiver and the emitter may be collocated, and a reflector positioned to return light emitted from the emitter for detection.

In this example, the detector 200 is to monitor, at any one time, one of the gaseous content of a fabrication chamber 102 and the output of an agent distributor 104. Operation of the fan 208 may not be constant during operation of the detector 200: drops of agent may fall through the sampling volume 206 under the action of gravity. Therefore, in some examples, the fan 208 is operated when the gaseous content of a fabrication chamber is to be sampled, but not when acting to detect drops of agent. In some examples, the fan 208 may be operable at a range of speeds (for example, a range of voltages may be used to drive the fan 208), each related to an airflow speed. For example, when the concentration of particles is high, the fan 208 may be controlled to run more slowly such that individual particles within an airflow may be more readily detectable.

FIG. 3 shows the output from a drop detector comprising a fan to cause an airflow through a sampling volume when in use to sample the gaseous content of a fabrication chamber. In this example, a detector comprises detection apparatus comprising a light emitter and a light receiver. FIG. 3 shows a series of dips, indicating that light is blocked, which in turn is an indication that a particle has passed through the detector. The dips tend to be followed by peaks, caused by dazzle of the light receiver after a period of operation in low light conditions as particles blocks the light.

This output allows the number of particles which are suspended in the gaseous content of a fabrication chamber which passes through the sampling volume to be determined. If the volume of gas which has moved through the sampling volume is also available (which may be determined from the speed of flow through the sampling volume), this allows the concentration of particles suspended in the gaseous content of the fabrication chamber (also referred to as ‘airborne’ particles herein, although it will be appreciated that the gaseous content may be some gas other than atmospheric air) to be estimated from the sample. Detection of drops of agent may be carried out in much the same manner, although as has been mentioned above, a detector fan may not be operated during a drop monitoring operation.

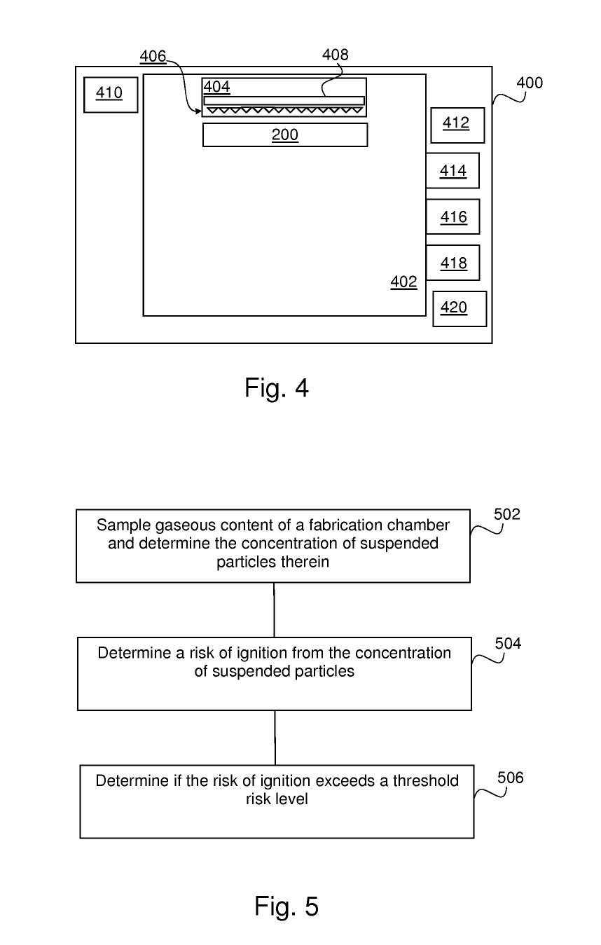

FIG. 4 shows a further example of three-dimensional object generation apparatus 400 for generating a three-dimensional object from a build material, which may be a granular build material. The apparatus 400 comprises a fabrication chamber 402, which may be similar to that described in relation to FIG. 1. An agent distributor 404 comprises a set of nozzles 406 and a mechanism 408 to eject agent through a selected nozzle in the manner of an ‘inkjet’ printer print head. The apparatus comprises a detector 200 as described in relation to FIG. 2, a processor 410 to receive and process data gathered by the detector 200, and a controller 412 to control operation of the apparatus 400. The apparatus 400 further comprises an inert gas source 414, a fabrication chamber venting apparatus 416, an energy source 418 to apply energy to build material to cause a portion of the build material to coalesce, and a cooling apparatus 420, which in some examples cools at least one component of the apparatus 400 which may become hot in use, and may also cool a region of the apparatus 400, for example so as to cool the content of the fabrication chamber 402. The cooling apparatus 420 may comprise, for example, a fan and/or a refrigeration unit.

In some examples, the detector 200 may be smaller than the agent distributor 404 and moveably mounted so that it can be repositioned to monitor different nozzles.

In this example, the processor 410 receives data gathered by the detector 200 and uses this data to determine if agent is actually ejected from a selected nozzle as intended, and thereby can determine a performance indication for the agent distributor 404. In addition, the processor 410 uses data gathered by the detector 200 to determine an estimate of concentration of particles within the gaseous content (i.e. ‘airborne’ particles) of the fabrication chamber 402. Such particles may be, or may mostly be made up of, particles of granular build material. Further, in this example, the processor 410 determines an indication of the size of the particles moving through the sampling volume 206. This may be determined from consideration of the duration of the interruption of the light beam by a particle (i.e. the transit time of a particle through at least a region of the sampling volume 206) and from knowledge of the airflow speed. In other examples, the particle size may be determined from the detector signal. For example, if the whole of a detector surface is covered by a particle, then the light may be blocked entirely and the signal may reduce to zero. If the particle is smaller and covers half a detector surface, then the signal will be reduced, but greater than zero. Therefore, in some examples, the magnitude of the signal may be used to provide an indication of particle size.

For a given concentration of particles, (which may for example be expressed in grams per cubic meter), ignition energy can vary according to particle size (which may for example be expressed in microns), with smaller particles generally being associated with an increased risk of ignition. Therefore, knowledge of particle size can increase the accuracy of a determination of the risk of ignition.

In this example, the controller 412 controls component(s) of the apparatus 400 in response to a determination by the processor 410 that the concentration of dispersed, airborne, particles (which may be particles in a predetermined range of sized) exceeds a threshold concentration. In this example, the controller 410 can operate to stop generation of an object by the apparatus 410 in response to such a determination. In other examples the controller 412 may (i) control the inert gas source 414 so as to introduce inert gas into the fabrication chamber 402 to reduce the risk that any particles therein could ignite by displacing oxygen, (ii) control the fabrication chamber venting apparatus 416 to vent the fabrication chamber 402, thereby removing suspended particles; (iii) stop the energy source 418 from applying energy thus reducing heat and thereby the risk of ignition; and/or (iv) apply or increase cooling by the cooling apparatus 420. Such risk reduction measures could be taken independently or in any combination. In one such example, the energy source 418 is stopped (which may comprises pausing operation to restart once the apparatus 400 has cooled) whilst continuing to operate the cooling apparatus 420.

FIG. 5 shows an example of a method of determining a risk of ignition of airborne particles within three-dimensional object generation apparatus. In some examples, the apparatus may be apparatus as described in relation to FIG. 1 or FIG. 4. In block 502, the gaseous content of a fabrication chamber of the apparatus is sampled and the concentration of suspended particles therein is determined. In block 504, a risk of ignition is determined from the concentration of suspended particles. In block 506, it is determined whether the risk of ignition exceeds a threshold risk level.

Determination of the risk of ignition could also comprise a consideration of particle size. This may be determined by detection apparatus or it may be that the build material particle size (granulometry) distribution is available, and such information could be used in determining a risk of ignition. For example particles in a first size range could contribute to a determination of risk of ignition or to a determination of particle concentration, while those in a second size range do not, or contribute to a lesser extent.

Such a method allows remedial action to be taken in the event that risk of ignition becomes too great. This in turn means that, in some examples, it may not be necessary to continually maintain an inert environment for fabrication, given that an unacceptable risk of ignition may occur rarely. Instead, such a risk could be dealt with reactively.

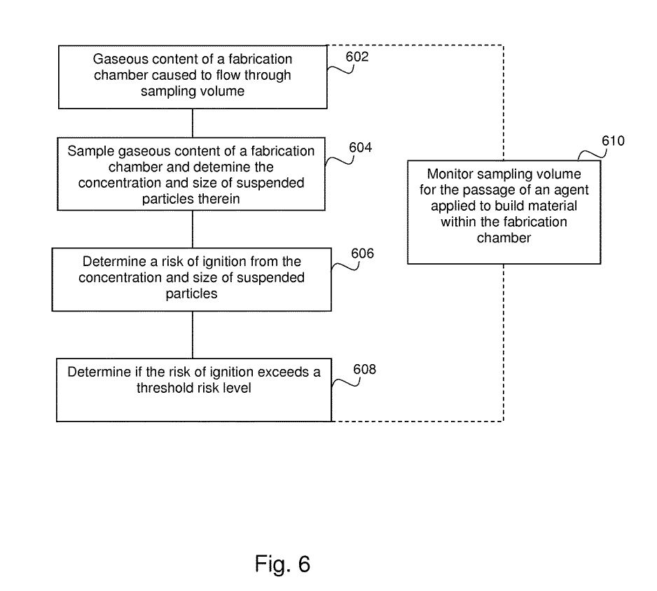

FIG. 6 shows another example of a method of determining a risk of ignition of airborne particles within three-dimensional object generation apparatus. In this example, in block 602, the gaseous content is caused to flow through a sampling volume at a predetermined flow rate. This flow rate may be variable, for example being slower when concentration is high such that particles tend to pass detection apparatus individually, thus allowing individual detection thereof. In addition, in block 604, sampling is carried out, which in this example comprises, in addition to determining the concentration of suspended particles as described in relation to FIG. 5, determining particle size. A risk of ignition is determined (block 606), and the risk compared to a threshold risk (block 608), for example as described above in relation to FIG. 5. In addition, but not necessarily concurrently, in block 610, the sampling volume is monitored for the passage of an agent applied to build material within the fabrication chamber.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

Any machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices provide a means for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

Features discussed in relation to one example may replace, or be replaced by, features from another example.

The features of any dependent claim may be combined with the features of any of the independent claims or other dependent claims.

1. A print head drop detector comprising
a sampling volume;
a fan to cause an airflow though the sampling volume; and
detection apparatus to detect the presence of non-gaseous material within the sampling volume.

2. A print head drop detector according to claim 1 wherein the non-gaseous material comprises airborne particles of build material used in generating a three-dimensional object and fluids dispensed from a print head.

3. A print head drop detector according to claim 1 in which the fan is to selectively cause airflow at a predetermined rate.

4. Three-dimensional object generation apparatus comprising:
a fabrication chamber in which an object is generated;
an agent distributor to selectively deliver an agent onto portions of a layer of build material within the fabrication chamber; and
a detector to monitor the ejection of agent from the agent distributor and to monitor the gaseous content of the fabrication chamber for particles dispersed therein.

5. Apparatus according to claim 4 in which the detector comprises:
i. a sampling volume; and
ii. a fan to cause gaseous content of the fabrication chamber to flow through the sampling volume.

6. Apparatus according to claim 4 which comprises a processor to receive data from the detector and to determine:
i. a performance indication for the agent distributor; and
ii. a concentration of particles within the gaseous content of the fabrication chamber.

7. Apparatus according to claim 6 in which the agent distributor comprises a set of nozzles and a mechanism to eject agent through a selected nozzle, and the processor is to determine if agent is ejected from a selected nozzle.

8. Apparatus according to claim 6 in which the processor is to determine an indication of the size of a particle detected within the gaseous content of the fabrication chamber.

9. Apparatus according to claim 8 in which the detector comprises a sampling volume and the processor is to determine an indication of the size of a particle from at least one of
i. a transit time of a particle through at least a region of the sampling volume; and
ii. a detector signal magnitude.

10. Apparatus according to claim 4 comprising a controller to control the apparatus in response to a determination that a concentration of dispersed particles exceeds a threshold concentration.

11. Apparatus according to claim 10 in which the controller is to stop generation of an object by the apparatus in response to a determination that a concentration of dispersed particles exceeds a threshold concentration.

12. Apparatus according to claim 10 in which the apparatus comprises at least one of:
i. an inert gas source, and the controller is to control the inert gas source so as to introduce inert gas into the fabrication chamber in response to a determination that a concentration of dispersed particles exceeds a threshold concentration;
ii. fabrication chamber venting apparatus, and the controller is to control the fabrication chamber venting apparatus to vent the fabrication chamber in response to a determination that a concentration of dispersed particles exceeds a threshold concentration;
iii. an energy source to apply energy to build material to cause a portion of the build material to coalesce, and the controller is to stop the energy source from applying energy in response to a determination that a concentration of dispersed particles exceeds a threshold concentration;
iv. a cooling apparatus to cool at least one component or region of the apparatus for generating a three-dimensional object, and the controller is to initiate or increase operation of the cooling apparatus in response to a determination that a concentration of dispersed particles exceeds a threshold concentration.

13. A method of determining a risk of ignition of airborne particles within three-dimensional object generation apparatus, the method comprising:
i. sampling the gaseous content of a fabrication chamber of the apparatus and determining a concentration of suspended particles therein;
ii. determining a risk of ignition from the concentration of suspended particles;
iii. determining if the risk of ignition exceeds a threshold risk level.

14. A method according to claim 13 wherein the method further comprises monitoring the sampling volume for the passage of an agent applied to build material within the fabrication chamber.

15. A method according to claim 14 in which sampling further comprises causing the gaseous content to flow through a sampling volume at a flow rate such that the passage of individual particles through the sampling volume may be detected.
